(19) United States
(12) Patent Application Publication
(10) Pub. No.: US 2010/0150233 A1
(43) Pub. Date: Jun. 17, 2010

(54) FAST MODE DECISION APPARATUS AND METHOD

(76) Inventors: Seunghwan KIM, Daejeon (KR); Young-Suk YOON, Daejeon (KR); Wonyoung YOO, Daejeon (KR); Young Ho SUH, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/477,741

(22) Filed: Jun. 3, 2009

(30) Foreign Application Priority Data
Dec. 15, 2008 (KR) 10-2008-0126928

(51) Int. Cl. H04N 7/12

(52) U.S. Cl. 375/240.12; 375/E07.001

(57) ABSTRACT

A fast mode decision apparatus includes a data storage for storing therein data on a reference picture, a per-mode calculator for computing values on a macroblock to be encoded and a mode decision unit for determining an optimal encoding mode for the macroblock to be encoded based on the values computed by the per-mode calculator and data on the reference picture stored in the data storage. The apparatus further includes a mode deactivator for deactivating P8×8 mode I4×4 mode, wherein the mode decision unit selects, as the optimal encoding mode, one among modes other than the modes deactivated by the mode deactivator.

### CROSS-REFERENCE(S) To RELATED APPLICATION(S)

The present invention claims priority of Korean Patent Application No. 10-2008-0126928, filed on Dec. 15, 2008, which is incorporated herein by reference.

### FIELD OF THE INVENTION

The present invention relates to fast mode decision for video coding; and, more particularly, to a fast mode decision apparatus and method for video coding, which includes two-stage early skip mode decision, two-stage early 16×16 mode decision and deactivation of P8×8 and I4×4 modes based on statistical rate-distortion estimation.

### BACKGROUND OF THE INVENTION

H.264 video coding standard is the latest video coding technique substituting MPEG-4 Visual and is widely used for various multimedia services.

In the H.264 standard, a 16×16 macroblock is subdivided into smaller subblocks for motion description, and a mode minimizing residual error for the subdivided blocks is selected as an optimal mode and used in encoding data to be transmitted, thereby reducing residual data and increasing compression efficiency.

In this case, a single macroblock may have a maximum of sixteen motion vectors with smaller partitioning, causing an increase in data to be transmitted. Hence, the standard applies a rate-distortion cost function to select an encoding mode requiring minimum number of bits.

However, as in the H.264 standard, taking all encoding modes into consideration in selecting an optimal encoding mode for each macroblock through the use of the rate-distortion cost function significantly lengthens encoding time for an input video.

### SUMMARY OF THE INVENTION

In view of the above, the present invention provides to an apparatus and method that can skip unnecessary motion prediction and mode decision procedures, by estimating rate-distortion of a macroblock to be encoded based on statistical properties of rate-distortions previously obtained from a reference picture.

In accordance with an aspect of the present invention, there is provided a fast mode decision apparatus for video coding, including:

a data storage for storing therein rate-distortions, mean rate-distortions and mean distortions of macroblocks in a reference picture in respective modes;

a per-mode calculator for computing a distortion of a macroblock to be encoded in a current picture in skip mode, motion vectors of the macroblock to be encoded in the skip and 16×16 mode and rate-distortions of the macroblock to be encoded in the skip, 16×16, 16×8 and 8×16 mode; and

a mode decision unit for determining an optimal encoding mode for the macroblock to be encoded based on the values computed by the per-mode calculator and data on the reference picture stored in the data storage.

Preferably, the mode decision unit sets the optimal encoding mode to the skip mode based on the distortion of the macroblock to be encoded in the skip mode and the mean distortion of the reference picture in the skip mode.

Preferably, the mode decision unit sets the optimal encoding mode to the skip mode based on the motion vector and rate-distortion of the macroblock to be encoded in the 16×16 mode and the motion vector and rate-distortion of the macroblock to be encoded in the skip mode.

Preferably, the mode decision unit sets the optimal encoding mode to the 16×16 mode based on the rate-distortion of the macroblock to be encoded in the 16×16 mode and the mean rate-distortion of the reference picture in the 16×16 mode.

Preferably, the mode decision unit sets the optimal encoding mode to the 16×16 mode based on the rate-distortions of the macroblock to be encoded in the 16×16, 16×8 and 8×16 modes.

The fast mode decision apparatus may further include a mode deactivator for deactivating P8×8 mode if a first minimum rate-distortion of the macroblock to be encoded is less than a first threshold and deactivating I4×4 mode if a second minimum rate-distortion of the macroblock to be encoded is less than a second threshold, wherein the mode decision unit selects, as the optimal encoding mode, one among modes other than the modes deactivated by the mode deactivator.

Preferably the first minimum rate-distortion is the minimum one among the rate-distortions in the 16×8 and 8×16 modes and the first threshold is the rate-distortion of the reference picture in the P8×8 mode multiplied by a specific weight.

Preferably, the second minimum rate-distortion is the minimum one among the rate-distortions in the 16×8, 8×16 and P8×8 modes and the second threshold is the rate-distortion of the reference picture in the I4×4 mode multiplied by a specific weight.

In accordance with another aspect of the present invention, there is provided a fast mode decision method for video coding, including:

setting an optimal encoding mode for a macroblock to be encoded in a current picture to skip mode, based on a mean distortion of macroblocks set to the skip mode in a reference picture and a distortion of a macroblock in the reference picture at a position same to that of the macroblock to be encoded;

setting the optimal encoding mode to the skip mode, based on a motion vector and rate-distortion of the macroblock to be encoded in 16×16 mode and a motion vector and rate-distortion of the macroblock to be encoded in the skip mode;

setting the optimal encoding mode to 16×16 mode, based on the rate-distortion of the macroblock to be encoded in the 16×16 mode and a mean rate-distortion of the reference picture in the 16×16 mode; and

setting the optimal encoding mode to the 16×16 mode, based on the rate-distortions of the macroblock to be encoded in the 16×16, 16×8 and 8×16 modes.

Preferably, said setting the optimal encoding mode to the skip mode based on the mean distortion and the distortion includes:

determining whether a distortion of the macroblock to be encoded in the skip mode is less than an weighted sum of the mean distortion of the macroblocks set to the skip mode in the reference picture and the distortion of the macroblock in the reference picture at the position same to that of the macroblock to be encoded; and

setting the optimal encoding mode to the skip mode if the distortion of the macroblock to be encoded in the skip mode is less than the weighted sum.

Preferably, said setting the optimal encoding mode to the skip mode based on the motion vectors and the rate-distortions is carried out if the distortion of the macroblock to be encoded in the skip mode is equal to or greater than the weighted sum.

Preferably, in said setting the optimal encoding mode to the skip mode based on the motion vectors and the rate-distortions, the optimal encoding mode is set to the skip mode, if the motion vector of the macroblock to be encoded in the 16×16 mode is identical to that in the skip mode and the rate-distortion of the macroblock to be encoded in the 16×16 mode is less than that in the skip mode.

Preferably, said setting the optimal encoding mode to the 16×16 mode based on the rate-distortion and the mean rate-distortion in the 16×16 mode is carried out, if the motion vector of the macroblock to be encoded in the 16×16 mode is different from that in the skip mode or the rate-distortion of the macroblock to be encoded in the 16×16 mode is equal to or greater than that in the skip mode.

Preferably, in said setting the optimal encoding mode to the 16×16 mode based on the rate-distortion and the mean rate-distortion in the 16×16 mode, the optimal encoding mode is set to the 16×16 mode, if the rate-distortion of the macroblock to be encoded in the 16×16 mode is less than the mean rate-distortion of the reference picture in the 16×16 mode multiplied by a specific weight.

Preferably, said setting the optimal encoding mode to the 16×16 mode based on the rate-distortions in the 16×16, 16×8 and 8×16 modes is carried out, if the rate-distortion of the macroblock to be encoded in the 16×16 mode is equal to or greater than the mean rate-distortion of the reference picture in the 16×16 mode multiplied by a specific weight.

Preferably, in said setting the optimal encoding mode to the 16×16 mode based on the rate-distortions in the 16×16, 16×8 and 8×16 modes, the optimal encoding mode is set to the 16×16 mode, if the rate-distortion of the macroblock to be encoded in the 16×16 mode is less than the rate-distortion of the macroblock to be encoded in the 16×8 mode and less than the rate-distortion of the macroblock to be encoded in the 8×16 mode.

The fast mode decision method may further includes deactivating P8×8 mode if a first minimum rate-distortion of the macroblock to be encoded is less than a first threshold; and deactivating I4×4 mode if a second minimum rate-distortion of the macroblock to be encoded is less than a second threshold, wherein the optimal encoding mode is selected among modes other than the deactivated modes.

Preferably, said deactivating the P8×8 mode is carried out if the rate-distortion of the macroblock to be encoded in the 16×16 mode is equal to or greater than the rate-distortion of the macroblock to be encoded in the 16×8 mode or equal to or greater than the rate-distortion of the macroblock to be encoded in the 8×16 mode.

Preferably, the first minimum rate-distortion is the minimum one among the rate-distortions in the 16×8 and 8×16 modes and the first threshold is the rate-distortion of the reference picture in the P8×8 mode multiplied by a specific weight.

Preferably, the second minimum rate-distortion is the minimum one among the rate-distortions in the 16×8, 8×16 and P8×8 modes and the second threshold is the rate-distortion of the reference picture in the I4×4 mode multiplied by a specific weight.

According to the present invention, skip mode and 16×16 mode can be set as an optimal mode at an early stage of mode decision through two-stage early skip mode decision and two-stage early 16×16 mode decision, respectively. Further, in continued optimal mode decision, P8×8 mode and I4×4 mode, which have low occurring frequencies and requiring complicated and long computations, can be deactivated based on statistical rate-distortion estimation. Thus, the encoding time can be shortened without degradation of encoding performance.

In comparison to the existing H.264 standard, fast mode decision of the present invention can reduce the encoding time by about 79% on average, while maintaining nearly the same performance in terms of PSNR (Peak Signal-to-Noise Ratio) and bit occurrence rate. Hence, H.264 based real-time coding capability can be provided.

### BRIEF DESCRIPTION OF THE DRAWINGS

The above features of the present invention will become apparent from the following description of embodiments, given in conjunction with the accompanying drawings, in which:

FIG. 1A illustrates mean rate-distortions in respective modes having different quantization parameter values;

FIG. 1B illustrates mode occurrence rates of respective modes having different quantization parameter values;

FIG. 2 illustrates a block diagram of an H.264 encoder having a fast mode decision apparatus in accordance with the present invention;

FIGS. 3A and 3B illustrate a flowchart of a fast mode decision method in accordance with the present invention;

FIG. 4 illustrates bit rates and distortions in skip mode;

FIG. 5 illustrates mean rate-distortions in P8×8 mode; and

FIG. 6 illustrates mean rate-distortions in intra modes.

### DETAILED DESCRIPTION OF THE EMBODIMENTS

Hereinafter, embodiments of the present invention will be described in detail with reference to the accompanying drawings, which form a part hereof.

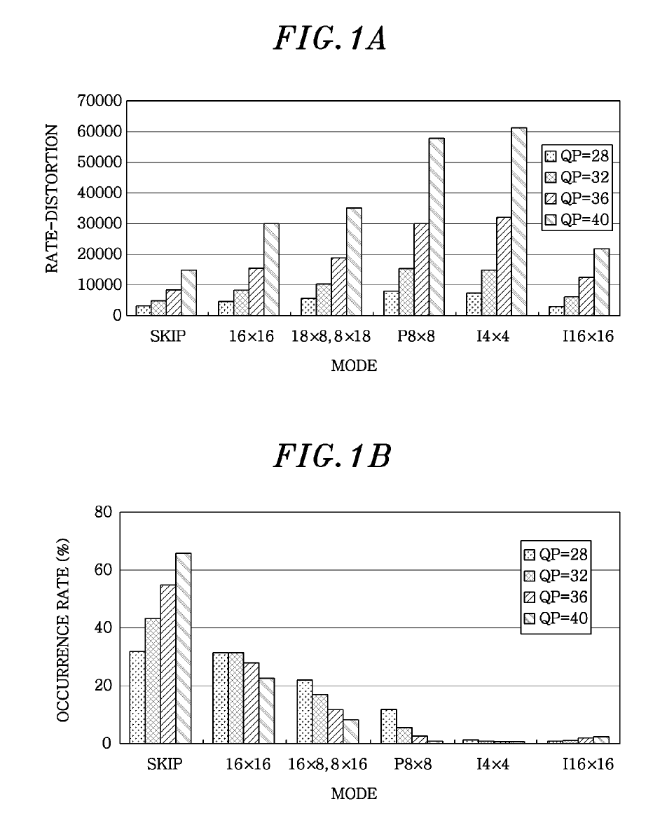

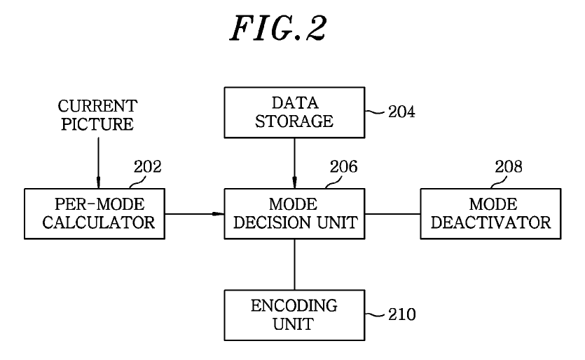

FIG. 1A illustrates mean rate-distortions in respective modes having different quantization parameter values. In FIG. 1A, each macroblock is encoded in an optimal mode thereof through rate-distortion optimization. As shown in FIG. 1A, each mode shows different rate-distortion distribution, i.e., rate-distortion cost, and particularly, skip mode has the least cost while P8×8 mode and I4×4 (intra 4×4) mode have costs over five times as large as that of the skip mode on average.

FIG. 1B illustrates mode occurrence rates of respective modes having different quantization parameter values. As shown in FIG. 1B, the skip mode occurs most frequently and 16×16 mode occurs next most frequently. Since the skip mode and the 16×16 mode occupy about 80 percent of the total number of mode occurrences, early skip mode decision and early 16×16 mode decision are very important in mode decision procedure for fast mode decision.

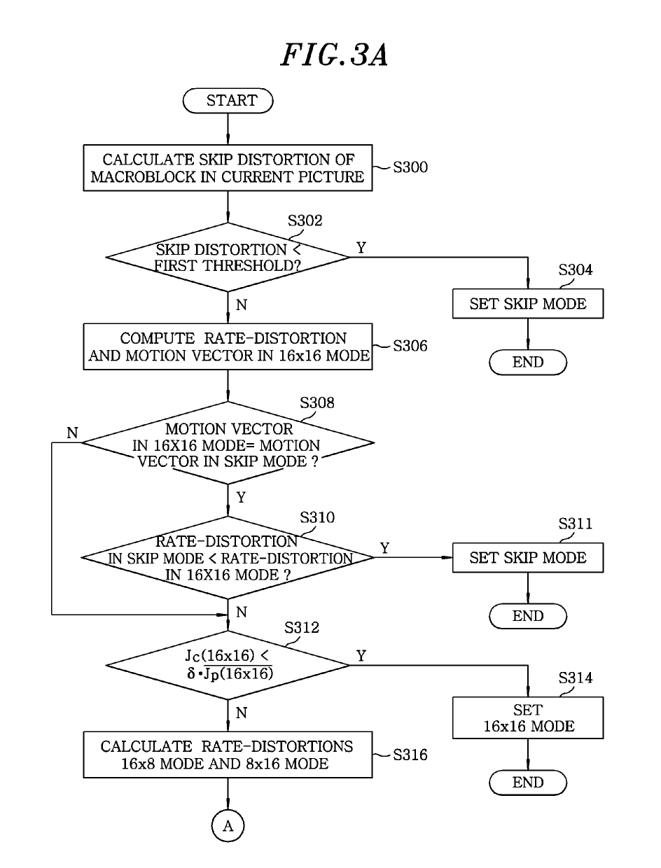

Hence, in the present invention, rate-distortion of a macroblock to be encoded in a current picture is estimated based on statistical properties of rate-distortions previously obtained from a reference picture, thereby skipping unnecessary motion prediction and mode decision, which will be described in detail with reference to FIGS. 2 to 6.

FIG. 2 illustrates a block diagram of an H.264 encoder having a fast mode decision apparatus in accordance with the present invention.

Referring to FIG. 2, the H.264 encoder includes a per-mode calculator 202, a data storage 204, a mode decision unit 206, a mode deactivator 208 and an encoding unit 210.

The per-mode calculator 202 calculates, values for a macroblock to be encoded in a current picture, e.g., a skip distortion, a motion vector in 16×16 mode and rate-distortions in 16×8 mode and 8×16 mode. The per-mode calculator 202 predicts a motion vector in skip mode based on the motion vector in the 16×16 mode.

The data storage 204 stores therein rate-distortions of macroblocks in a reference picture for respective modes.

For example, the data storage 204 stores therein, for each macroblock in the reference picture, a mean skip distortion and rate-distortions in P8×8 mode and I4×4 mode.

The mode decision unit 206 determines an optimal macroblock encoding mode. To be specific, the mode decision unit 206 may complete mode decision procedure at early stages thereof by setting, based on the values calculated by the per-mode calculator 202 and data on the reference picture stored in the data storage 204, the skip mode or the 16×16 mode as the optimal mode. If the mode decision unit 206 fails to set the skip mode or the 16×16 mode as the optimal mode at the early stages of the mode decision procedure, the mode decision unit 206 takes all encoding modes other than modes deactivated by the mode deactivator 208 into consideration in selecting the optimal encoding mode for the macroblock to be encoded.

The mode deactivator 208 determines whether to deactivate modes, e.g., the P8×8 mode and/or I4×4 mode, having low occurrence frequencies and relatively high rate-distortions, in optimal mode decision.

The encoding unit 210 encodes the macroblock to be encoded in the current picture by using the optimal mode determined by the mode decision unit 206, and transmits the encoded picture to the outside via a transmission channel.

Below, a mode decision procedure performed in the H.264 encoder having the above-described configuration will be described.

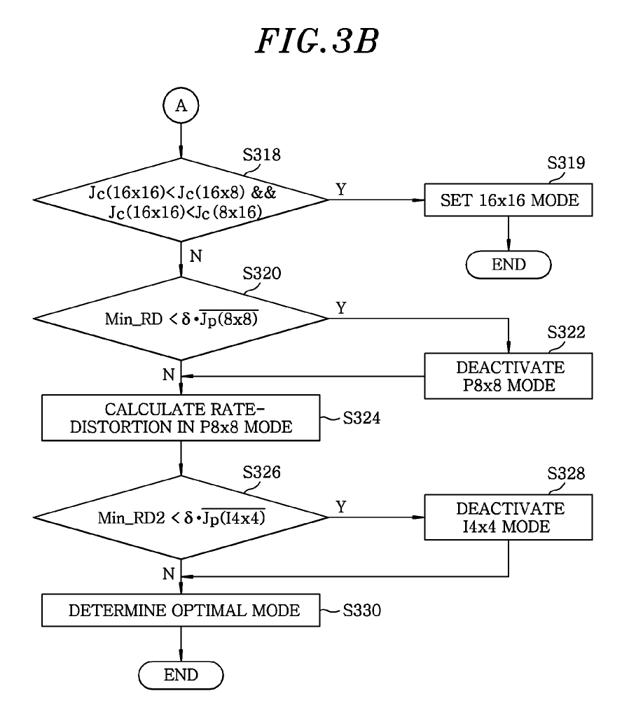

FIGS. 3A and 3B illustrate a flowchart of a fast mode decision method in accordance with the present invention.

As shown in FIG. 3A, the method includes two early skip mode decision stages. In a first early skip mode decision stage, whether to set the skip mode as the optimal mode is determined by using an weighted mean skip distortion of macroblocks set to the skip mode in the reference picture and a distortion of a macroblock located in the reference picture at a position same to that of a macroblock to be encoded in the current picture. To be specific, it is determined whether a condition as defined in Equation 1 is satisfied:

$${D}_{c} ( SKIP \vert QP ) < δ \times \{ \frac{α \times \overline{{D}_{p} ( SKIP \vert QP )} + {D}_{p} ( M \vert QP )}{α + 1} \} , \qquad Equation 1$$

where D_{c}(SKIP|QP) denotes a skip distortion of a macroblock to be encoded in the current picture, D̅ₚ̅(̅S̅K̅I̅P̅|̅Q̅P̅)̅ denotes the mean skip distortion of the reference picture and Dₚ(M|QP) denotes the distortion of the macroblock located in the reference picture at a position same to that of a macroblock to be encoded. α is a constant serving as an weight between D̅ₚ̅(̅S̅K̅I̅P̅|̅Q̅P̅)̅ and Dₚ(M|QP), and δ is a constant for use in adjusting complexity and coding efficiency of the fast mode decision algorithm. A large δ results in low complexity and high coding efficiency.

Referring back to FIG. 3A, in the first early skip mode decision stage, the per-mode calculator 202 of the H.264 encoder calculates the skip distortion of the macroblock to be encoded in the current picture (step S300), and provides the calculated skip distortion to the mode decision unit 206. The mode decision unit 206 compares the calculated skip distortion with a first threshold, i.e., the right-hand side of Equation 1 (step S302).

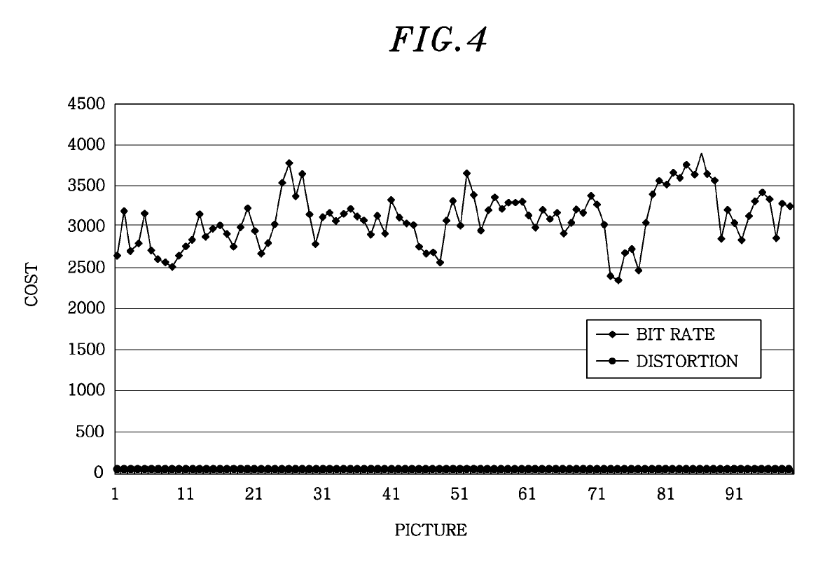

Since bit rates in the skip mode are much lower than distortion values therein as shown in FIG. 4, the skip mode decision of the present invention uses distortion values instead of rate-distortions.

If the calculated skip distortion is less than the first threshold, the mode decision unit 206 sets the skip mode as the optimal mode for the macroblock to be encoded (step S304). If the calculated skip distortion is not less than the first threshold, the per-mode calculator 202 computes a motion vector and rate-distortion of the macroblock to be encoded in the 16×16 mode (step S306).

The mode decision unit 206 checks whether the motion vector in the 16×16 mode are identical to that in the skip mode (step S308). If the motion vector in the 16×16 mode are identical to that in the skip mode, the mode decision unit 206 compares a rate-distortion in the skip mode with that in the 16×16 mode (step S310). Here, the motion vector in the skip mode can be obtained by using the motion vector in the 16×16 mode.

If it is determined in the step 310 that the rate-distortion in the skip mode is less than that in the 16×16 mode, the mode decision unit 206 sets the skip mode as the optimal mode (step S311). If it is determined in the step 310 that the rate-distortion in the skip mode is not less than that in the 16×16 mode, the mode decision unit 206 compares the rate distortion J_{c}(16×16) in the 16×16 mode with a second threshold δ· J̅ₚ̅(̅1̅6̅×̅1̅6̅)̅ (step S312). Here, the second threshold δ· J̅ₚ̅(̅1̅6̅×̅1̅6̅)̅ is the mean rate-distortion J̅ₚ̅(̅1̅6̅×̅1̅6̅)̅ of the reference picture in the 16×16 mode weighted by the weight δ, the mean rate-distortion J̅ₚ̅(̅1̅6̅×̅1̅6̅)̅ being retrieved from the data storage 204.

Further, if it is determined in the step S308 that the motion vector in the 16×16 mode is different from the motion vector in the skip mode, the control jumps to the step S312.

If it is determined in the step S312 that the rate-distortion in the 16×16 mode is less than the second threshold, the mode decision unit 206 sets the 16×16 mode to the optimal mode (step S314). If the rate-distortion in the 16×16 mode is not less than the second threshold, the per-mode calculator 202 calculates rate-distortions of the macroblock to be encoded in the 16×8 mode and the 8×16 mode (step S316).

Referring to FIG. 3B, the mode decision unit 206 checks whether the rate-distortion J_{c}(16×16) in the 16×16 mode is less than both of the rate-distortions J_{c}(16×8) and J_{c}(8×16) in the 16×8 mode and the 8×16 mode, respectively (step S318).

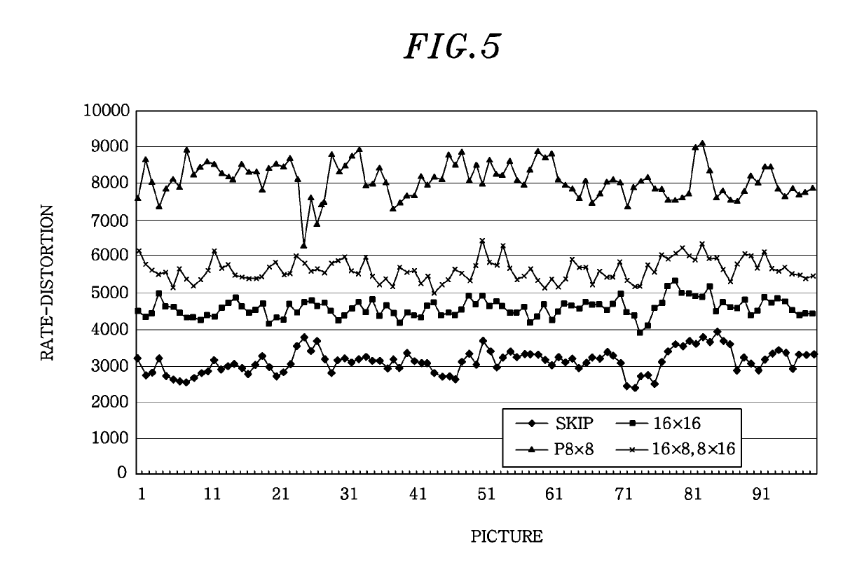

If the rate distortion in the 16×16 mode is less than both of the rate-distortions in the 16×8 mode and the 8×16 mode, the mode decision unit 206 sets the optimal mode to the 16×16 mode (step S319). If the rate distortion in the 16×16 mode is not less than either the rate-distortion in the 16×8 mode or that in the 8×16 mode, the mode deactivator 208 determines whether to skip (deactivate) the P8×8 mode in continued optimal mode decision, based on the minimum rate-distortion of the macroblock to be encoded and a mean rate-distortion J̅ₚ̅(̅8̅×̅8̅)̅ of the reference picture in the P8×8 mode, the mean rate-distortion of the reference picture being estimated through statistical observations (step S320). Since occurrence rate of P8×8 mode is very low and rate-distortions in the P8×8 mode are much higher than those in other modes as shown in FIG. 5, skipping the P8×8 mode is determined in the step S320 using Equation 2:

Min_{—}RD cos t{16×8,8×16}<δ· J̅ₚ̅(̅P̅8̅×̅8̅)̅, Equation 2

where Min_RDcost{16×8,8×16} denotes the minimum rate-distortion among rate-distortions in the 16×8 mode and the 8×16 mode, and J̅_̅{̅P̅}̅(̅P̅8̅×̅8̅)̅ denotes the mean rate-distortion of the reference picture in the 8×8 mode.

In the step S320, the mode deactivator 208 obtains the minimum rate-distortion Min_RDcost{16×8,8×16} from the rate distortions in the 16×8 mode and the 8×16 mode, and checks whether the minimum rate-distortion Min_RDcost{16×8,8×16} is less than a third threshold, which is δ· J̅ₚ̅(̅P̅8̅×̅8̅)̅ in Equation 2. If the minimum rate-distortion Min_RDcost{16×8,8×16} is less than the third threshold δ· J̅ₚ̅(̅P̅8̅×̅8̅)̅, the mode deactivator 208 deactivates the P8×8 mode (step S322). Thereafter, the per-mode calculator 202 computes rate distortion of the macroblock to be encoded in the P8×8 mode (step S324).

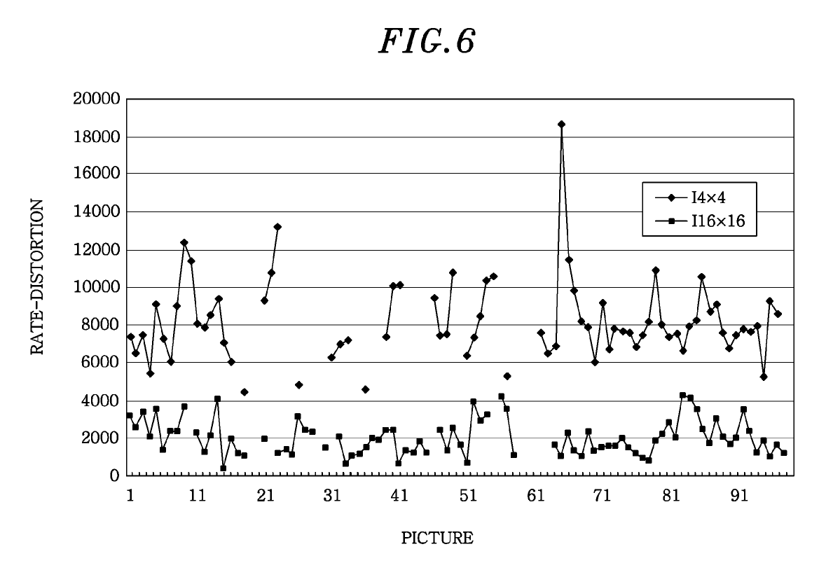

Also, since the I4×4 mode requires more header bits, the I4×4 mode has very low occurrence rate and a rate-distortion thereof is much higher than those of other modes as shown in FIG. 6. In consideration of this, the mode deactivator 208 determines whether to deactivate the I4×4 mode using Equation 3:

Min_{—}RD cos t{16×8,8×16,P8×8}<δ· J̅ₚ̅(̅P̅4̅×̅4̅)̅, Equation 3

where Min_RDcost{16×8,8×16,P8×8} denotes the minimum rate-distortion among rate-distortions in the 16×8 mode, the 8×16 mode and the P8×8 mode, and J̅ₚ̅(̅P̅4̅×̅4̅)̅ denotes the mean rate-distortion of the reference picture in the I4×4 mode.

The mode deactivator 206 obtains the minimum rate-distortion Min_RDcost{16×8,8×16,P8×8} from rate-distortions of the 16×8 mode, 8×16 mode and P8×8 mode, and checks whether the minimum rate-distortion Min_RDcost{16×8,8×16,P8×8} is less than a firth threshold, which is δ· J̅ₚ̅(̅I̅4̅×̅4̅)̅ in Equation 3 (step S326). If the minimum rate-distortion Min_RDcost{16×8,8×16,P8×8} is less than the firth threshold δ· J̅ₚ̅(̅I̅4̅×̅4̅)̅, the mode deactivator 208 deactivates the I4×4 mode (step S328). Thereafter, the mode decision unit 206 determines the optimal mode (step S330).

In the step S330, the mode decision unit 206 takes all encoding modes other than the P8×8 mode and/or the I4×4 mode deactivated by the mode deactivator 208 into consideration in selecting the optimal encoding mode for the macroblock to be encoded.

The mode decision apparatus of the present invention may be implemented as computer-executable codes stored in a computer-readable storage medium. The computer-readable storage medium may be any of storage media that can store data readable by a computer system. Examples of the computer-readable storage medium include a ROM, RAM, CD-ROM, magnetic tape, hard disk, floppy disk, flash memory, optical data storage and carrier wave (for transmission through the Internet). The computer-executable codes may be distributed among and executed by computer systems connected through a network to carry out desired functions in a distributed manner. Font ROM data structures of the present invention may also be implemented as computer-executable codes stored in a computer-readable storage medium such as a ROM, RAM, CD-ROM, magnetic tape, hard disk, floppy disk, flash memory or optical data storage.

While the invention has been shown and described with respect to the embodiments, it will be understood by those skilled in the art that various changes and modification may be made without departing from the scope of the invention as defined in the following claims.

What is claimed is:

1. A fast mode decision apparatus for video coding, comprising:
a data storage for storing therein rate-distortions, mean rate-distortions and mean distortions of macroblocks in a reference picture in respective modes;
a per-mode calculator for computing a distortion of a macroblock to be encoded in a current picture in skip mode, motion vectors of the macroblock to be encoded in the skip and 16×16 mode and rate-distortions of the macroblock to be encoded in the skip, 16×16, 16×8 and 8×16 mode; and
a mode decision unit for determining an optimal encoding mode for the macroblock to be encoded based on the values computed by the per-mode calculator and data on the reference picture stored in the data storage.

2. The fast mode decision apparatus of claim 1, wherein the mode decision unit sets the optimal encoding mode to the skip mode based on the distortion of the macroblock to be encoded in the skip mode and the mean distortion of the reference picture in the skip mode.

3. The fast mode decision apparatus of claim 1, wherein the mode decision unit sets the optimal encoding mode to the skip mode based on the motion vector and rate-distortion of the macroblock to be encoded in the 16×16 mode and the motion vector and rate-distortion of the macroblock to be encoded in the skip mode.

4. The fast mode decision apparatus of claim 1, wherein the mode decision unit sets the optimal encoding mode to the 16×16 mode based on the rate-distortion of the macroblock to be encoded in the 16×16 mode and the mean rate-distortion of the reference picture in the 16×16 mode.

5. The fast mode decision apparatus of claim 1, wherein the mode decision unit sets the optimal encoding mode to the 16×16 mode based on the rate-distortions of the macroblock to be encoded in the 16×16, 16×8 and 8×16 modes.

6. The fast mode decision apparatus of claim 1, further comprising:
a mode deactivator for deactivating P8×8 mode if a first minimum rate-distortion of the macroblock to be encoded is less than a first threshold and deactivating I4×4 mode if a second minimum rate-distortion of the macroblock to be encoded is less than a second threshold,
wherein the mode decision unit selects, as the optimal encoding mode, one among modes other than the modes deactivated by the mode deactivator.

7. The fast mode decision apparatus of claim 6, wherein the first minimum rate-distortion is the minimum one among the rate-distortions in the 16×8 and 8×16 modes and the first threshold is the rate-distortion of the reference picture in the P8×8 mode multiplied by a specific weight.

8. The fast mode decision apparatus of claim 6, wherein the second minimum rate-distortion is the minimum one among the rate-distortions in the 16×8, 8×16 and P8×8 modes and the second threshold is the rate-distortion of the reference picture in the I4×4 mode multiplied by a specific weight.

9. A fast mode decision method for video coding, comprising:
setting an optimal encoding mode for a macroblock to be encoded in a current picture to skip mode, based on a mean distortion of macroblocks set to the skip mode in a reference picture and a distortion of a macroblock in the reference picture at a position same to that of the macroblock to be encoded;
setting the optimal encoding mode to the skip mode, based on a motion vector and rate-distortion of the macroblock to be encoded in 16×16 mode and a motion vector and rate-distortion of the macroblock to be encoded in the skip mode;
setting the optimal encoding mode to 16×16 mode, based on the rate-distortion of the macroblock to be encoded in the 16×16 mode and a mean rate-distortion of the reference picture in the 16×16 mode; and
setting the optimal encoding mode to the 16×16 mode, based on the rate-distortions of the macroblock to be encoded in the 16×16, 16×8 and 8×16 modes.

10. The fast mode decision method of claim 9, wherein said setting the optimal encoding mode to the skip mode based on the mean distortion and the distortion includes:
determining whether a distortion of the macroblock to be encoded in the skip mode is less than an weighted sum of the mean distortion of the macroblocks set to the skip mode in the reference picture and the distortion of the macroblock in the reference picture at the position same to that of the macroblock to be encoded; and
setting the optimal encoding mode to the skip mode if the distortion of the macroblock to be encoded in the skip mode is less than the weighted sum.

11. The fast mode decision method of claim 10, wherein said setting the optimal encoding mode to the skip mode based on the motion vectors and the rate-distortions is carried out if the distortion of the macroblock to be encoded in the skip mode is equal to or greater than the weighted sum.

12. The fast mode decision method of claim 11, wherein in said setting the optimal encoding mode to the skip mode based on the motion vectors and the rate-distortions, the optimal encoding mode is set to the skip mode, if the motion vector of the macroblock to be encoded in the 16×16 mode is identical to that in the skip mode and the rate-distortion of the macroblock to be encoded in the 16×16 mode is less than that in the skip mode.

13. The fast mode decision method of claim 12, wherein said setting the optimal encoding mode to the 16×16 mode based on the rate-distortion and the mean rate-distortion in the 16×16 mode is carried out, if the motion vector of the macroblock to be encoded in the 16×16 mode is different from that in the skip mode or the rate-distortion of the macroblock to be encoded in the 16×16 mode is equal to or greater than that in the skip mode.

14. The fast mode decision method of claim 13, wherein in said setting the optimal encoding mode to the 16×16 mode based on the rate-distortion and the mean rate-distortion in the 16×16 mode, the optimal encoding mode is set to the 16×16 mode, if the rate-distortion of the macroblock to be encoded in the 16×16 mode is less than the mean rate-distortion of the reference picture in the 16×16 mode multiplied by a specific weight.

15. The fast mode decision method of claim 14, wherein said setting the optimal encoding mode to the 16×16 mode based on the rate-distortions in the 16×16, 16×8 and 8×16 modes is carried out, if the rate-distortion of the macroblock to be encoded in the 16×16 mode is equal to or greater than the mean rate-distortion of the reference picture in the 16×16 mode multiplied by a specific weight.

16. The fast mode decision method of claim 15, wherein in said setting the optimal encoding mode to the 16×16 mode based on the rate-distortions in the 16×16, 16×8 and 8×16 modes, the optimal encoding mode is set to the 16×16 mode, if the rate-distortion of the macroblock to be encoded in the 16×16 mode is less than the rate-distortion of the macroblock to be encoded in the 16×8 mode and less than the rate-distortion of the macroblock to be encoded in the 8×16 mode.

17. The fast mode decision method of claim 16, further comprising:
deactivating P8×8 mode if a first minimum rate-distortion of the macroblock to be encoded is less than a first threshold; and
deactivating I4×4 mode if a second minimum rate-distortion of the macroblock to be encoded is less than a second threshold,
wherein the optimal encoding mode is selected among modes other than the deactivated modes.

18. The fast mode decision method of claim 17, wherein said deactivating the P8×8 mode is carried out if the rate-distortion of the macroblock to be encoded in the 16×16 mode is equal to or greater than the rate-distortion of the macroblock to be encoded in the 16×8 mode or equal to or greater than the rate-distortion of the macroblock to be encoded in the 8×16 mode.

19. The fast mode decision method of claim 18, wherein the first minimum rate-distortion is the minimum one among the rate-distortions in the 16×8 and 8×16 modes and the first threshold is the rate-distortion of the reference picture in the P8×8 mode multiplied by a specific weight.

20. The fast mode decision method of claim 19, wherein the second minimum rate-distortion is the minimum one among the rate-distortions in the 16×8, 8×16 and P8×8 modes and the second threshold is the rate-distortion of the reference picture in the I4×4 mode multiplied by a specific weight.
